(19) United States
(12) Patent Application Publication
(10) Pub. No.: US 2026/0162873 A1
(43) Pub. Date: Jun. 11, 2026

(54) COIL COMPONENT

(71) Applicant: SAMSUNG ELECTRO-MECHANICS CO., LTD., Suwon-si (KR)

(72) Inventors: Doo Ho Park, Suwon-si (KR); Jae Hun Kim, Suwon-si (KR); Su Min Seo, Suwon-si (KR); Boum Seock Kim, Suwon-si (KR); Min Ji Cho, Suwon-si (KR); Ju Hwan Yang, Suwon-si (KR)

(73) Assignee: SAMSUNG ELECTRO-MECHANICS CO., LTD., Suwon-si (KR)

(21) Appl. No.: 19/380,531

(22) Filed: Nov. 5, 2025

(30) Foreign Application Priority Data
Dec. 9, 2024 (KR) 10-2024-0181301

(51) Int. Cl. H01F 27/28; H01F 27/06; H01F 27/24

(52) U.S. Cl. CPC H01F 27/28; H01F 27/06; H01F 27/24

(57) ABSTRACT

A coil component includes a body including a magnetic material, a support member disposed within the body, the support member including a plurality of groove portions formed in one surface thereof, and a coil disposed on the one surface of the support member, the coil forming at least one turn. The plurality of groove portions includes a plurality of first groove portions formed in one region of the one surface of the support member, in which the coil is disposed, and a plurality of second groove portions formed in the other region of the one surface of the support member, in which the coil is not disposed. An average of depths of the plurality of first groove portions is greater than an average of depths of the plurality of second groove portions.

### CROSS-REFERENCE TO RELATED APPLICATION(S)

This application claims benefit of priority to Korean Patent Application No. 10-2024-0181301 filed on Dec. 9, 2024 in the Korean Intellectual Property Office, the disclosure of which is incorporated herein by reference in its entirety.

### TECHNICAL FIELD

The present disclosure relates to a coil component.

An inductor, a coil component, may be a representative passive electronic component used in electronic devices, along with a resistor and a capacitor.

With the advancement of IT technologies, a reduction in size and thickness of various electronic devices has been accelerating, and accordingly, thin-film inductors used in such electronic devices have also been required to have a reduced size and thickness.

As power inductors have a reduced thickness, research and development has been conducted to increase the number of turns of the coil pattern (fine patterning) and to increase a height of a coil pattern in order to achieve a reduction in size of a product without loss of chip properties such as inductance and Rdc.

As a coil pattern becomes finer, adhesion between the coil pattern and a substrate may decrease, which may lead to coil lifting defects.

### SUMMARY

An aspect of the present disclosure is to provide a coil component capable of achieving fine patterning of a coil pattern while securing adhesion to a support member.

According to an aspect of the present disclosure, there is provided a coil component including a body including a magnetic material, a support member disposed within the body, the support member including a plurality of groove portions in a first surface of the support member, and a coil disposed on the first surface of the support member, the coil including at least one turn. The plurality of groove portions may include a plurality of first groove portions in a first region of the first surface of the support member, on which the coil is disposed, and a plurality of second groove portions in a second region of the first surface of the support member, on which the coil is not disposed. An average of depths of the plurality of first groove portions may be greater than an average of depths of the plurality of second groove portions.

According to another aspect of the present disclosure, there is provided a coil component including a body including a magnetic material, a support member disposed within the body, the support member having a first surface and a second surface opposing the first surface, and each of the first surface and the second surface has a roughness; and a coil disposed on the first surface of the support member, the coil including at least one turn. A first region of the first surface of the support member, on which the coil is disposed, may have a first roughness, and a second region of the first surface of the support member, on which the coil is not disposed, may have a second roughness. A ten-point average roughness (Rz) of the first roughness may be greater than a ten-point average roughness (Rz) of the second roughness.

According to the present disclosure, a coil component may achieve fine patterning of a coil pattern while securing adhesion to a support member.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic view of a coil component according to an example embodiment of the present disclosure;

FIG. 2 is a cross-sectional view taken along line I-I′ of FIG. 1;

FIG. 3 is a cross-sectional view taken along line II-II′ of FIG. 1;

FIG. 4 is an enlarged view of portion “A” of FIG. 2;

FIGS. 5A and 5B are view of a roughness curve of a groove portion of FIG. 4; and

FIGS. 6A to 6E are schematic view of a manufacturing process of a coil component according to the present example embodiment.

### DETAILED DESCRIPTION

The terms used herein is for the purpose of describing particular example embodiments only and is not to be limiting of the example embodiments. As used herein, the singular forms “a,” “an,” and “the” are intended to include the plural forms as well, unless the context clearly indicates otherwise. As used herein, the term “and/or” includes any one and any combination of any two or more of the associated listed items. It will be further understood that the terms “comprises” and/or “comprising,” when used in this code, specify the presence of stated features, integers, steps, operations, elements, components or a combination thereof, but do not preclude the presence or addition of one or more other features, integers, steps, operations, elements, components, and/or groups thereof. In addition, the terms “disposed on,” “positioned on,” and the like, may mean that an element is positioned on or below a target portion, and may not necessarily mean that the element is positioned on an upper side of the target portion with respect to a direction of gravity.

The terms “coupled to,” “connected to,” and the like, may not only indicate that elements are directly and physically in contact with each other, but also include a configuration in which another element is interposed between the elements such that the elements are also in contact with the other element.

The size and thickness of each element illustrated in the drawings is arbitrarily represented for ease of the description, but the present disclosure is not limited to those illustrated herein.

In the drawings, an X-direction may be defined as a first direction or a length direction, a Y-direction may be defined as a second direction or a width direction, and a Z-direction may be defined as a third direction or a thickness direction.

Hereinafter, a coil component according to an example embodiment of the present disclosure will be described in detail with reference to the accompanying drawings. In the description with reference to the accompanying drawings, the same or corresponding elements are denoted by the same reference numerals and repeated descriptions thereof will be omitted.

Various types of electronic components may be used in electronic devices, and various types of coil components may be appropriately used between such electronic components to remove noise.

That is, in an electronic device, a coil component may be used as a power inductor, a high frequency (HF) inductor, a general bead, a high-frequency bead (GHz bead), a common mode filter, or the like.

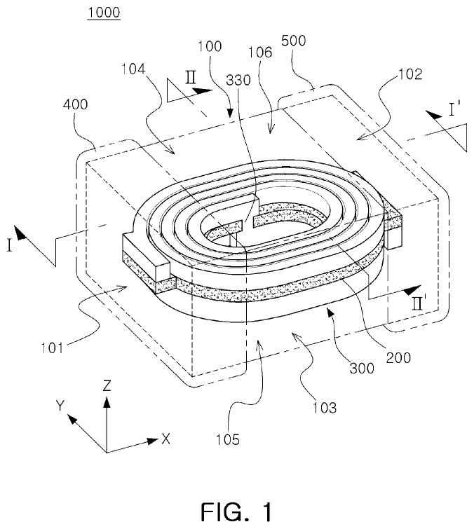

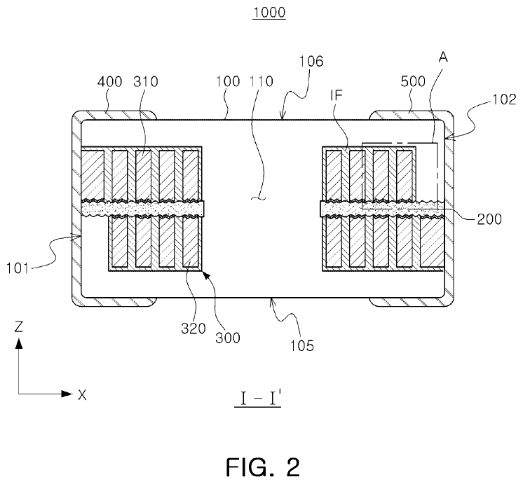

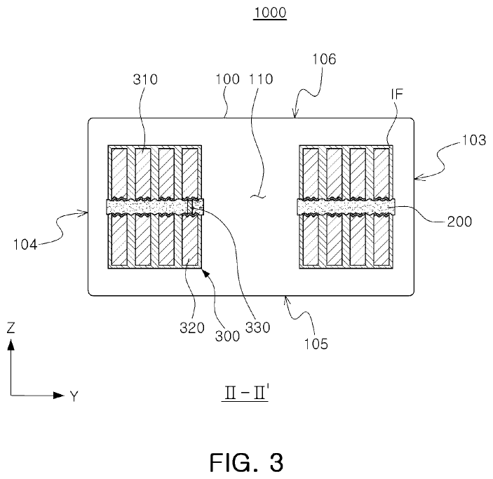

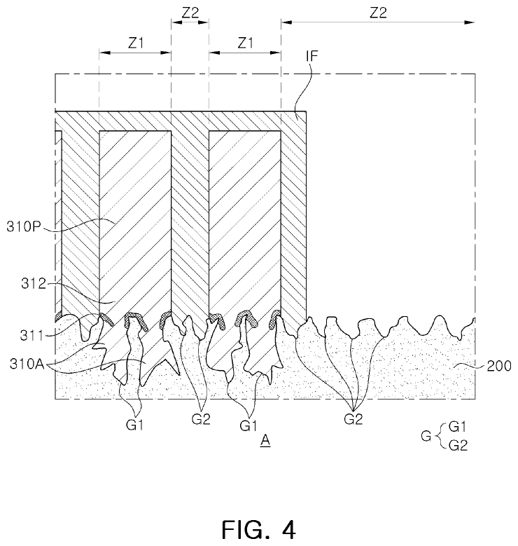

FIG. 1 is a schematic view of a coil component according to an example embodiment of the present disclosure. FIG. 2 is a cross-sectional view taken along line I-I′ of FIG. 1. FIG. 3 is a cross-sectional view taken along line II-II′ of FIG. 1. FIG. 4 is an enlarged view of portion “A” of FIG. 2.

Referring to FIGS. 1 to 4, a coil component 1000 according to an example embodiment of the present disclosure may include a body 100, a support member 200, and a coil 300, and may further include external electrodes 400 and 500 and an insulating film IF.

The body 100 may form the overall exterior of the coil component 1000 according to the present example embodiment, and may include the support member 200 and the coil 300 buried therein.

The body 100 may have an overall hexahedral shape.

Referring to FIGS. 1 to 3, the body 100 may include a first surface 101 and a second surface 102 opposing each other in a length direction (X-direction), a third surface 103 and a fourth surface 104 opposing each other in a width direction (Y-direction), and a fifth surface 105 and a sixth surface 106 opposing each other in a thickness direction (Z-direction). Each of the first to fourth surfaces 101, 102, 103, and 104 of the body 100 may correspond to a side surface of the body 100 connecting the fifth surface 105 and the sixth surface 106 to each other.

The body 100 may be formed such that the coil component 1000 according to the present example embodiment, in which the external electrodes 400 and 500 to be described below are formed, may have a length of 0.8 mm, a width of 0.65 mm, and a thickness of 0.45 mm, but the present disclosure is not limited thereto. The above-described sizes of the coil component 1000 are merely exemplary, and a case in which the coil component 1000 has a size other than the above-described sizes is not excluded from the scope of the present disclosure.

The body 100 may include magnetic powder particles and an insulating resin. Specifically, the body 100 may be formed by laminating one or more magnetic composite sheets including an insulating resin and magnetic powder particles dispersed in the insulating resin, and then curing the magnetic composite sheets. However, the body 100 may have a structure other than a structure in which the magnetic powder particles are dispersed in the insulating resin. For example, the body 100 may be formed of a magnetic material such as ferrite.

The magnetic powder particles may be, for example, ferrite powder particles or metal magnetic powder particles.

The ferrite powder particles may be, for example, at least one of spinel-type ferrite powder particles such as Mg—Zn-based ferrite powder particles, Mn—Zn-based ferrite powder particles, Mn—Mg-based ferrite powder particles, Cu—Zn-based ferrite powder particles, Mg—Mn—Sr-based ferrite powder particles, Ni—Zn-based ferrite powder particles, or the like, hexagonal ferrite powder particles such as Ba—Zn-based ferrite powder particles, Ba—Mg-based ferrite powder particles, Ba—Ni-based ferrite powder particles, Ba—Co-based ferrite powder particles, Ba—Ni—Co-based ferrite powder particles, or the like, garnet-type ferrite powder particles such as Y-based ferrite powder particles or the like, or Li-based ferrite powder particles.

The magnetic metal powder particles may include one or more selected from the group consisting of iron (Fe), silicon (Si), chromium (Cr), cobalt (Co), molybdenum (Mo), aluminum (Al), niobium (Nb), copper (Cu), and nickel (Ni). For example, the magnetic metal powder particles may be at least one of pure iron powder particles, Fe—Si-based alloy powder particles, Fe—Si—Al-based alloy powder particles, Fe—Ni-based alloy powder particles, Fe—Ni—Mo-based alloy powder particles, Fe—Ni—Mo—Cu-based alloy powder particles, Fe—Co-based alloy powder particles, Fe—Ni—Co-based alloy powder particles, Fe—Cr-based alloy powder particles, Fe—Cr—Si-based alloy powder particles, Fe—Si—Cu—Nb-based alloy powder particles, Fe—Ni—Cr-based alloy powder particles, or Fe—Cr—Al-based alloy powder particles.

The magnetic metal powder particles may be amorphous or crystalline. For example, the magnetic metal powder particles may be Fe—Si—B—Cr-based amorphous alloy powder particles, but the present disclosure is not necessarily limited thereto.

Each of the ferrite powder particles and the magnetic metal powder particles may have an average diameter of about 0.1 μm to about 30 μm, but the present disclosure is not limited thereto.

The body 100 may include two or more types of magnetic materials dispersed in the resin. Here, different types of magnetic materials mean that the magnetic materials are distinguished from each other in terms of one of an average diameter, a composition, crystallinity, and a shape. For example, the body 100 may include two or more types of magnetic powders having different particle diameters.

The insulating resin may include epoxy, polyimide, a liquid crystal polymer, or the like alone or in combination, but the present disclosure is not limited thereto.

The body 100 may include a core 110 passing through the support member 200 and the coil 300 to be described below. During a process of laminating and curing magnetic composite sheets, the core 110 may be formed by filling a through-hole of the coil 300 with at least a portion of the magnetic composite sheets, but the present disclosure is not limited thereto.

The support member 200 may have one surface and the other surface, and may be buried in the body 100, together with the coil 300 to be described below. The support member 200 may be configured to support the coil 300. In the present example embodiment, for ease of description, the one surface of the support member 200 is described, but the present disclosure is not limited thereto. The description of the one surface of the support member 200 may be equally applied to the other surface.

The support member 200 may be formed of an insulating material including a thermosetting insulating resin such as an epoxy resin, a thermoplastic insulating resin such as polyimide, or a photosensitive insulating resin, or an insulating material in which a reinforcing material, such as a glass fiber or an inorganic filler, is impregnated with the above-described insulating resins. For example, the support member 200 may be formed of an insulating material such as a copper clad laminate (CCL), a prepreg, an Ajinomoto build-up film (ABF), FR-4, a bismaleimide triazine (BT) resin, a photoimageable dielectric (PID), or the like, but the present disclosure is not limited thereto.

The inorganic filler may be at least one selected from the group consisting of silica (SiO₂), alumina (Al₂O₃), silicon carbide (SiC), barium sulfate (BaSO₄), talc, mud, mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), and calcium zirconate (CaZrO₃).

When the support member 200 is formed of an insulating material including a reinforcing material, the support member 200 may provide more excellent rigidity. When the support member 200 is formed of an insulating material, not including glass fiber, the support member 200 may be advantageous for a reduction in an overall thickness of the coil 300. When the support member 200 is formed of an insulating material including a photosensitive insulating resin, the number of processes for formation of the coil 300 may be reduced. Thus, it may be advantageous in reducing production costs, and a fine via may be formed.

Referring to FIGS. 2 to 4, the support member 200 may include a plurality of groove portions G formed in one surface thereof.

The groove portions G may have a shape recessed inwardly from the one surface of the support member 200. As illustrated in FIG. 4, the plurality of groove portions G may be formed along the one surface of the support member 200, and the plurality of groove portions G may be spaced apart from each other. The groove portions G may be formed through a desmearing process, a plasma treatment process, or the like.

Referring to FIG. 4, the one surface of the support member 200 may be divided into one region Z1 and the other region Z2. The coil 300 may be disposed in the one region Z1, and the coil 300 may not be disposed in the other region Z2.

The other region Z2 may include a region of the one surface of the support member 200 between adjacent turns of the coil 300.

A plurality of first groove portions G1 may be formed in the one region Z1. A plurality of second groove portions G2 may be formed in the other region Z2. The coil component according to the present example embodiment may be divided into the one region Z1 and the other region Z2, and the groove portions G may have different depths in the respective regions.

The first groove portion G1 may be formed in the one region Z1 of the one surface of the support member, in which the coil is disposed. Referring to FIG. 4, a plurality of first groove portions G1 are formed in a lower portion of the coil pattern 310. It is illustrated that two first groove portions G1 are formed in one turn of the coil, but the number of groove portions is not limited thereto. One turn may have three or more first groove portions G1, and may be different from remaining turns in terms of the number of first groove portions G1.

The second groove portion G2 may be formed in the other region Z2 of the one surface of the support member, in which the coil is not disposed. The second groove portion G2 may also be formed in a region between adjacent turns of the coil. The second groove portion G2 may be formed as a plurality of second groove portions G2.

Generally, a groove portion may be formed in one surface of a support member using a desmearing process or plasma etching process to improve adhesion with a coil. However, when the above process is performed on the entire one surface, unintended residues such as a DFR or the like may remain in the groove portion of the support member. When such residues are disposed on a lower portion of the support member in which the coil is disposed, adhesion between the coil and the support member may rather be degraded.

Accordingly, the coil component according to the present example embodiment may selectively improve a roughness of one region Z1 of one surface of a support member in which a coil is disposed. Specifically, an average of depths of the plurality of first groove portions G1 may be greater than an average of depths of the plurality of second groove portions G2.

When only the second groove portion G2 having a relatively small depth is formed in the entire one surface of the support member 200, adhesion between the coil 300 and the support member 200 may be degraded. In addition, when only the first groove portion G1 having a relatively large depth is formed in the entire one surface of the support member 200, residues of the DFR may remain on the support member 200. As a result, adhesion between the coil 300 and the support member 200 may be weakened.

In the coil component according to the present example embodiment, the first groove portions G1 may be formed in the one region Z1 of the support member 200 in which the coil is disposed. In this case, the first groove portion G1 may be formed after the DFR is laminated and patterned. Accordingly, residues of the DFR may not remain in the first groove portion G1. As a result, adhesion between the coil 300 and the support member 200 may be reliably improved.

The one surface of the support member 200 of the coil component according to the present example embodiment may have a roughness. That is, the one surface of the support member 200 may have a roughness due to a plurality of groove portions G formed in the one surface of the support member 200. A roughness formed in the one region Z1 of the one surface of the support member in which the coil is disposed may be referred to as a first roughness, and a roughness formed in the other region Z2 of the one surface of the support member in which the coil is not disposed may be referred to as a second roughness.

The first roughness may be greater than the second roughness. Specifically, an Rz value of the first roughness may be greater than an Rz value of the second roughness. Here, Rz may refer to ten-point average roughness. A reference for measuring a roughness is not limited to Rz, and may also be measured based on an arithmetic average roughness (Ra) or maximum height roughness (Ry). Other methods and/or tools appreciated by one of ordinary skill in the art, even if not described in the present disclosure, may also be used.

When the Rz value of the first roughness is referred to as “a” and the Rz value of the second roughness is referred to as “b,” a−b may satisfy 1 μm or more to 5 μm or less.

When a−b is greater than 5 μm, a groove portion may be formed to have a significantly large depth. As a result, the support member 200 may have reduced rigidity. When a−b is less than 1 μm, bonding strength between the coil 300 and the support member 200 may not be sufficiently improved.

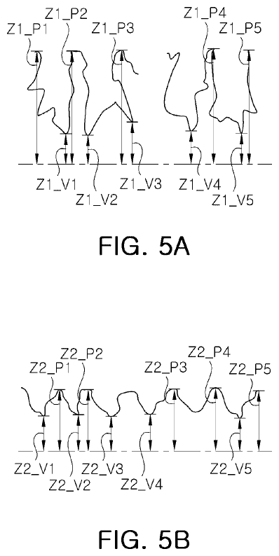

FIGS. 5A and 5B are diagram illustrating cross-sectional curves (roughness curves) of one region Z1 and the other region Z2 of a support member.

Referring to FIGS. 5A and 5B, in each groove portion of the one region Z1, a difference between a maximum height (P) and a minimum height (V) from a reference line may be obtained to measure a depth of each groove portion G1. A first groove portion G1 may be formed as a plurality of first groove portions G1, and thus depths of the plurality of first groove portions may be measured, and an arithmetic average of the depths may be calculated to obtain an average of the depths of the plurality of first groove portions. The depths of the plurality of first groove portions may be measured from an electron micrograph. Other methods and/or tools appreciated by one of ordinary skill in the art, even if not described in the present disclosure, may also be used.

Similarly, in each groove portion of the other region Z2, a difference between a maximum height (P) and a minimum height (V) from a reference line may be obtained to measure a depth of each groove portion G2. A second groove portion G2 may also be formed as a plurality of second groove portions G2, and thus depths of the plurality of second groove portions may be measured, and an arithmetic average of the depths may be calculated to obtain an average of the depths of the plurality of second groove portions. The depths of the plurality of first groove portions may be measured from an electron micrograph. Other methods and/or tools appreciated by one of ordinary skill in the art, even if not described in the present disclosure, may also be used.

In addition, a ten-point average roughness (Rz) may be measured using the following method.

Referring to FIGS. 5A and 5B, heights from the reference line to five highest peaks within a reference length of the one region Z1 may be denoted by Z1_P1 to Z1_P5. Similarly, heights from the reference line to five lowest valleys within the reference length of the one region Z1 may be denoted by Z1_V1 to Z1_V5.

A ten-point average roughness (Rz) of the one region Z1 may be a value obtained by subtracting an arithmetic average value of Z1_V1 to Z1_V5 from an arithmetic average value of Z1_P1 to Z1_P5.

Similarly, a ten-point average roughness (Rz) of the other region Z2 may be obtained by measuring peak heights Z2_P1 to Z2_P5) and valley heights Z2_V1 to Z2_V5 of the other region Z2.

In the coil component according to the present example embodiment, a plurality of groove portions G may also be formed in the other surface of the support member 200, and the other surface may have a roughness. The description of the plurality of groove portions and the roughness of the other surface may overlap the above description of the one surface, and thus will be omitted.

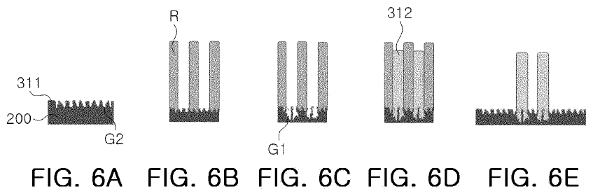

FIGS. 6A to 6E are schematic view of a manufacturing process of a coil component according to the present example embodiment.

Referring to FIG. 6A, a seed layer (first metal layer 311) may be formed on a support member 200 having one surface on which a second groove portion G2 is formed using desmear treatment or the like.

Subsequently, referring to FIG. 6B, a DFR R may be disposed on the support member, and a pattern may be formed on the DFR R.

Subsequently, referring to FIG. 6C, etching using a plasma process or the like may be performed on a space between DFRs on which the pattern is formed. A roughness may be selectively improved using the DFR on which the pattern is formed. Due to the etching process, a first groove portion G1 may be formed to have a relatively large depth, and unintended residues of the DFR may be removed.

Subsequently, referring to FIGS. 6D and 6E, a plating layer (second metal layer 312) of a coil may be formed on the first groove portion G1, and a support member having a coil may be obtained by peeling off the DFR.

A coil 300 may be disposed on one surface of the support member 200, and may form a plurality of turns to exhibit properties of the coil component. For example, when the coil component 1000 according to the present example embodiment is used as a power inductor, the coil 300 may serve to stabilize power of an electronic device by storing an electric field as a magnetic field and maintaining an output voltage.

The coil 300 may include a first coil pattern 310 disposed on the one surface of the support member 200, and a second coil pattern 320 disposed on the other surface of the support member 200. Hereinafter, the description will be provided based on the first coil pattern 310.

The coil 300 of the coil component according to the present example embodiment may cover a plurality of first groove portions G1. Referring to FIG. 4, the first coil pattern 310 may include an anchor portion 310A disposed in the plurality of first groove portions G1, and a pattern portion 310P protruding from the one surface of the support member 200.

The anchor portion 310A may be disposed in the plurality of first groove portions G1. The anchor portion 310A may be positioned on a level lower than that of the one surface of the support member 200, and may be disposed in the first groove portion G1. Thus, adhesion with the support member 200 may be secured through an anchor effect.

Referring to FIG. 4, one turn, among the plurality of turns of the coil 300, may include a plurality of anchor portions 310A, and the plurality of anchor portions 310A may be spaced apart from each other. As described above, one turn may include a plurality of anchor portions, thereby maximizing an anchor effect with the support member 200.

The pattern portion 310P may be disposed on the anchor portion 310A, and may protrude from the one surface of the support member 200. The pattern portion 310P may be positioned on a level higher than that of the one surface of the support member 200, and may form one or more turns to form the capacitance of the coil component.

A line width of the anchor portion 310A may be less than a line width of the pattern portion 310P. Here, the line width may refer to a length in a first direction (X-direction) in a cross-section of one turn of the first coil pattern 310 in a X-Z direction.

The coil 300 may have a multilayer structure including a first metal layer and a second metal layer. Referring to FIG. 4, the first coil pattern 310 may include a first metal layer 311 having at least a portion in contact with surfaces of the plurality of first groove portions G1, and a second metal layer 312 disposed on the first metal layer.

At least a portion of the first metal layer 311 may be disposed on the surfaces of the plurality of first groove portions G1. The first metal layer 311 may not cover at least a portion of the surface of the first groove portion G1. As described above, after the first metal layer 311 is formed, the first groove portion G1 is formed using a plasma method or the like, and thus the first metal layer 311 may not be disposed on at least a portion of the surface of the first groove portion G1.

Referring to FIG. 4, the first metal layer 311 may have a shape in which a portion of the first metal layer 311 appears to be floating without being contact with the support member 200. At least a portion of the first metal layer 311 may be spaced apart from the surface of the first groove portion G1, and the second metal layer 312 may be disposed in a space between at least a portion of the first metal layer 311 and the surface of the first groove portion G1. The second metal layer 312 may be disposed in the plurality of first groove portions G1 through the space to be in contact with the support member 200.

The first metal layer 311 may be positioned at a level between the one surface of the support member 200 and a lowest surface of a plurality of second groove portions. The first metal layer 311 may not be positioned on a level between the lowest surface of the plurality of second groove portions G2 and a lowest surface of the plurality of first groove portions G1. As described above, the first metal layer 311 may be formed on a surface of the support member 200 on which the second groove portion G2 is formed using a desmearing process or the like. Thus, the first metal layer 311 may be positioned on a level the same as or higher than the lowest surface of the second groove portion G2. In addition, the first groove portion G1 may be formed in a state in which the first metal layer 311 is disposed, and thus the first metal layer 311 may not be formed on a level lower than that of the lowest surface of the second groove portion G2. However, the present disclosure is not limited thereto. Here, the term “the same level” may refer to a case in which levels are substantially the same. That is, the term “the same level” may include not only levels that are exactly the same, but also those that may be regarded as the same by those skilled in the art, even when there is a slight difference within a tolerance range due to tolerances in a manufacturing process or material properties.

The first metal layer 311 may be formed using a thin film process such as sputtering or the like, or an electroless plating process. The first metal layer 311 may include at least one of copper (Cu), aluminum (Al), silver (Ag), tin (Sn), gold (Au), nickel (Ni), lead (Pb), titanium (Ti), chromium (Cr), molybdenum (Mo), or alloys thereof, and may be formed as at least one layer.

The second metal layer 312 may be disposed on the first metal layer 311, and at least a portion of the second metal layer 312 may be disposed in the first groove portion G1 of the support member. The second metal layer 312 may be formed by performing electroplating using the seed layer 310 as a seed, and may include at least one of copper (Cu), aluminum (Al), silver (Ag), tin (Sn), gold (Au), nickel (Ni), platinum (Pt), titanium (Ti), chromium (Cr), and alloys thereof, and may be formed as at least one layer.

The coil 300 may include first and second coil patterns 310 and 320 and a via 330. In the directions of FIGS. 1, 2, and 3, the first coil pattern 310 may be disposed on one surface of the support member 200 opposing a sixth surface 106 of a body 100, and the second coil pattern 320 may be disposed on the other surface, opposing the one surface of the support member 200.

The second coil pattern 320 may be disposed on the other surface of the support member 200 to cover the plurality of first groove portions formed in the other surface of the support member 200. The description of the second coil pattern 320 may overlap the description of the first coil pattern 310, and thus will be omitted.

Referring to FIGS. 1 to 3, the via 330 may pass through the support member 200 to be in contact with each of the first coil pattern 310 disposed on the one surface of the support member 200, and the second coil pattern 320 disposed on the other surface of the support member 200. Accordingly, the coil 300 may function as a single coil in which one or more turns are formed around the core 110.

The via 330 may include at least one plating layer. For example, when the via 330 is formed by electroplating, the via 330 may include a seed layer formed on an inner wall of a via hole passing through the support member 200, and an electroplating layer filling the via hole in which the seed layer is formed. The seed layer of the via 330 and the seed layer for forming the coil 300 may be formed together in the same process to be integrally formed with each other, or may be formed in different processes, such that boundaries therebetween may be formed. The via 330 may include a conductive material such as copper (Cu), aluminum (Al), silver (Ag), tin (Sn), gold (Au), nickel (Ni), lead (Pb), titanium (Ti), chromium (Cr), molybdenum (Mo), or alloys thereof.

An end of the coil 300 may be connected to the first and second external electrodes 400 and 500 to be described below. Referring to FIGS. 1 and 2, an end of the first coil pattern 310 may be exposed to the first surface 101 of the body 100 and connected to the first external electrode 400, and an end of the second coil pattern 320 may be exposed to the second surface 102 of the body 100 and connected to the second external electrode 500.

The first and second external electrodes 400 and 500 may be disposed on the first and second surfaces 101 and 102 of the body 100, respectively. The first external electrode 400 may be disposed on the first surface 101 of the body 100 and connected to the end of the first coil pattern 310. The second external electrode 500 may be disposed on the second surface 102 of the body 100 and connected to the end of the second coil pattern 320.

The first and second external electrodes 400 and 500 may have a structure including a single layer or a plurality of layers. For example, the first external electrode 400 may include a first layer including copper (Cu), a second layer including nickel (Ni), and a third layer including tin (Sn). Here, the first to third layers may be formed by plating, respectively, but the present disclosure is not limited thereto. As another example, the first external electrode 400 may include a resin electrode including conductive powder particles such as silver (Ag) and a resin, and a nickel (Ni)/tin (Sn) plating layer formed on the resin electrode.

The first and second external electrodes 400 and 500 may be formed of a conductive material such as copper (Cu), aluminum (Al), silver (Ag), tin (Sn), gold (Au), nickel (Ni), lead (Pb), titanium (Ti), or alloys thereof, but the present disclosure is not limited thereto.

Referring to FIGS. 2 to 4, an insulating film IF may be disposed along a surface of the coil 300.

The insulating film IF may insulate between the coil 300 and the body 100. The insulating film IF may cover an external surface of the coil 300, thereby insulating the coil 300 from the body 100. The insulating film IF may be disposed between adjacent turns of the coil, and may cover at least one of the plurality of second groove portions G2.

The insulating film IF may be formed in the form of a conformal film along the external surface of the coil 300.

The insulating film IF may include a known insulating material such as parylene or the like, but the present disclosure is not limited thereto. As another example, the insulating film IF may include an insulating material such as an epoxy resin or the like, rather than parylene. The insulating film IF may be formed by vapor deposition, but the present disclosure is not limited thereto. As another example, the insulating film IF may be formed by laminating and curing an insulating film for forming the insulating film IF on both surfaces of the support member 200 on which the coil 300 is formed. Alternatively, the insulating film IF may be formed by coating and curing an insulating paste for forming the insulating film IF on both surfaces of the support member 200 on which the coil 300 is formed.

In the present disclosure, the insulating film IF may be an optional element. When the body 100 is capable of securing sufficient electrical resistance under an operating condition of the coil component 1000 according to the present example embodiment, the insulating film IF may be omitted.

While example embodiments have been shown and described above, it will be apparent to those skilled in the art that modifications and variations could be made without departing from the scope of the present disclosure as defined by the appended claims.

What is claimed is:

1. A coil component comprising:
a body including a magnetic material;
a support member disposed within the body, the support member including a plurality of groove portions in a first surface of the support member; and
a coil disposed on the first surface of the support member, the coil including at least one turn,
wherein the plurality of groove portions includes a plurality of first groove portions in a first region of the first surface of the support member, on which the coil is disposed, and a plurality of second groove portions in a second region of the first surface of the support member, on which the coil is not disposed, and
an average of depths of the plurality of first groove portions is greater than an average of depths of the plurality of second groove portions.

2. The coil component of claim 1, wherein the coil includes a first metal layer at least partially in contact with surfaces of the plurality of first groove portions, and a second metal layer disposed on the first metal layer.

3. The coil component of claim 2, wherein
at least a portion of the first metal layer is spaced apart from the surfaces of the plurality of first groove portions, and
the second metal layer is disposed in a space between the first metal layer and the surfaces of the plurality of first groove portions.

4. The coil component of claim 2, wherein the second metal layer is disposed in the plurality of first groove portions to be in contact with the support member.

5. The coil component of claim 2, wherein the first metal layer is positioned on a level equal to or higher than a lowest surface of the plurality of second groove portions.

6. The coil component of claim 1, wherein the coil includes two or more turns, and the second region of the first surface of the support member includes a region of the first surface of the support member between adjacent turns among the two or more turns.

7. The coil component of claim 1, wherein the coil further includes an anchor portion disposed in the plurality of first groove portions, and a pattern portion protruding from the first surface of the support member.

8. The coil component of claim 7, wherein the coil includes two or more turns, at least one turn among the two or more turns of the coil includes a plurality of anchor portions, and the plurality of anchor portions are spaced apart from each other.

9. The coil component of claim 1, wherein the coil includes a first coil pattern disposed on the first surface of the support member, a second coil pattern disposed on a second surface of the support member, the second surface opposing the first surface of the support member, and a via passing through the support member to connect the first coil pattern and the second coil pattern to each other.

10. The coil component of claim 9, wherein the plurality of first groove portions and the plurality of second groove portions are also in the second surface of the support member.

11. The coil component of claim 1, further comprising:
an insulating film disposed along a surface of the coil.

12. The coil component of claim 11, wherein the coil includes two or more turns, and the insulating film is disposed between adjacent turns among the two or more turns to cover at least one of the plurality of second groove portions.

13. The coil component of claim 3, wherein
the second metal layer includes copper.

14. The coil component of claim 5, wherein the first metal layer is positioned on a level that is equal to the lowest surface of the plurality of second groove portions.

15. The coil component of claim 5, wherein the first metal layer is positioned on a level that is higher than the lowest surface of the plurality of second groove portions.

16. A coil component comprising:
a body including a magnetic material;
a support member disposed within the body, the support member having a first surface and a second surface opposing the first surface, and each of the first surface and the second surface has a roughness; and
a coil disposed on the first surface of the support member, the coil including at least one turn,
wherein a first region of the first surface of the support member, on which the coil is disposed, has a first roughness, and a second region of the first surface of the support member, on which the coil is not disposed, has a second roughness, and
a ten-point average roughness (Rz) of the first roughness is greater than a ten-point average roughness (Rz) of the second roughness.

17. The coil component of claim 16, wherein the ten-point average roughness (Rz) of the first roughness is denoted by a, and the ten-point average roughness (Rz) of the second roughness is denoted by b, and a−b satisfies 1 μm or more and 5 μm or less.

18. The coil component of claim 16, wherein the coil includes two or more turns, and the second region of the support member includes a region between adjacent turns among the two or more turns of the coil on the first surface of the support member.
